(19) United States
(12) Patent Application Publication
(10) Pub. No.: US 2006/0188125 A1
(43) Pub. Date: Aug. 24, 2006

(54) Audio signal adapter

(76) Inventors: Ringyu Cao, Tucheng City (TW); Mingcheng Zi, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/060,430

(22) Filed: Feb. 18, 2005

(51) Int. Cl. H04R 1/02; H04B 3/00; H01R 33/945

(52) U.S. Cl. 381/394; 381/77; 439/577

(57) ABSTRACT

The present invention provides an audio signal adapter, which includes a plug, a metal jack and a plastic set. The plug and the metal jack are electronically connected to two terminals of a cable respectively. The plug may be an earphone plug or a microphone plug. Correspondingly, the metal jack may be an earphone jack or a microphone jack. The plastic set includes a thin and flat base. The top central section of the base extends upward in order to form a socket. A slot is defined in the front of the socket. The metal jack is embedded in the slot. With the design of the thin and flat base, the plastic set can be firmly and conveniently fixed to the external ornament of the bag by typical assembling method such as sewing and sticking.

### BACKGROUND OF THE INVENTION

1. Field of the Invention

The present invention relates generally to a signal adapter, and more especially to an audio signal adapter, which transmits audio signals from an electronic device, such as MP3 (Media Player) to an electronic apparatus, such as an earphone and a microphone.

2. The Related Art

At present, more and more MP3 has a hard disc memory. Owing to the big volume and weight of the hard disc memory, it is inconvenient for users to dangle the MP3 in front of thorax or pack the MP3 to arm as carrying other general compact MP3. Consequently, the user often places the MP3 having a hard disc memory in a bag taken along. When using, the user can directly take the earphone throughout from the opening of the bag and listen. However, the earphone wire will be long and difficult to be gathered in. The earphone will drop because of accidental crashing of arm while walking or sporting. When the listening terminal drops from ears, the audio signal will be broken off, while the earphone plug accidental coming off from the MP3 jack will not only break off the function, but also damage the terminal of MP3 and the earphone plug easily. Actually, this phenomenon exists generally in other electronic device such as CD (Compact Disc) or mobile phone that has an earphone or a microphone.

Because the earphone wire is long and difficult to be gathered in, the drop of the earphone occurs frequently. In order to reduce the drop of the earphone, some bags specially provides with an earphone jack pocket and an adapter correspondingly. One terminal of the adapter is an earphone plug; the other terminal of the adapter is an earphone jack. The earphone plug is electronically connected to the earphone jack with a cable. In this way, the earphone plug and the cable are placed in the bag, and the earphone jack is placed in the earphone jack pocket. The earphone jack is generally assembled in a column socket. For this reason, the column socket cannot be sewed or stuck to fabric. The column socket is fixed by filling the earphone jack pocket with other material. In practice, a user can insert the earphone plug of the adapter into jack of the electronic device such as MP3 in the bag. The original earphone plug of the electronic device is inserted into the metal jack of the adapter. Then user can receive and transmit audio signals with original earphone. As described above, this adapter reduces the wire length of the receiving terminal, but the earphone jack pocket is filled with other material can not firmly and conveniently fixed the column socket into the earphone jack pocket. The column socket will still sway and even drop from the earphone jack pocket. Consequently, the related art cannot completely prevent drop of the earphone obviously.

### SUMMARY OF THE INVENTION

An object of the present invention is to provide an audio signal adapter, which can stably, conveniently fix a jack of an electronic apparatus to the external ornament of a shoulder bag, and transmit the audio signal from an electronic device, such as MP3, to an electronic apparatus, such as earphone and microphone. The audio signal adapter reduces the drop of the earphone and microphone and improves efficiency of assembling, remarkably.

To attain the above object, the present invention provides an audio signal adapter, which comprises a plug and a metal jack. The plug and the metal jack are electronically connected to the two terminals of a cable respectively. The metal jack is embedded in a plastic set. The plastic set includes a thin and flat base, which is fixed to an external ornament. The top central section of the base extends upward in order to form a socket. A slot is defined in the front of the socket. The metal jack is embedded in the slot. With the thin and flat base, the plastic set is firmly and conveniently fixed to the external ornament of the bag by typical assembling method such as sewing and sticking. The audio signal adapter, so as to reduce the frequent drop of the earphone and microphone, transmits the audio signal to the earphone or microphone.

### BRIEF DESCRIPTION OF THE DRAWINGS

A detailed explanation of a preferred embodiment of the present invention will be given, with reference to the attached drawings, for better understanding thereof to those skilled in the art:

FIG. 1 is a perspective view of the audio signal adapter in accordance with the present invention.

FIG. 2 is an exploded view showing the plastic set and the metal jack in accordance with the present invention.

### DETAILED DESCRIPTION OF THE PREFERRED EMBODIMENT

A detailed explanation of the present invention will be given, for better understanding thereof to those skilled in the art, construction feature, intended purpose and function, following is the description of an embodiment and the drawings.

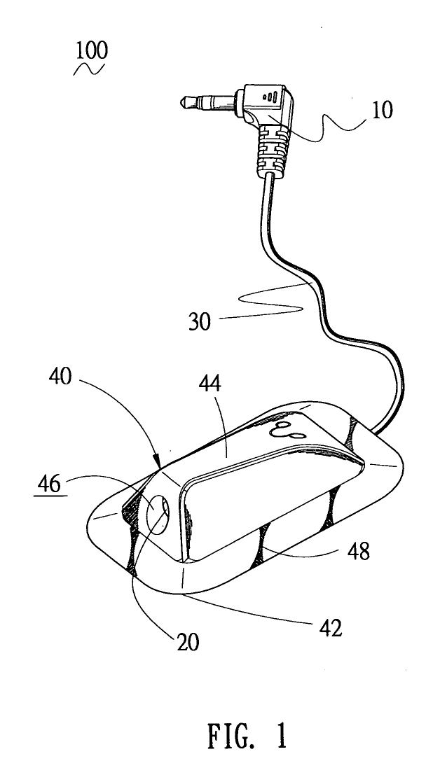

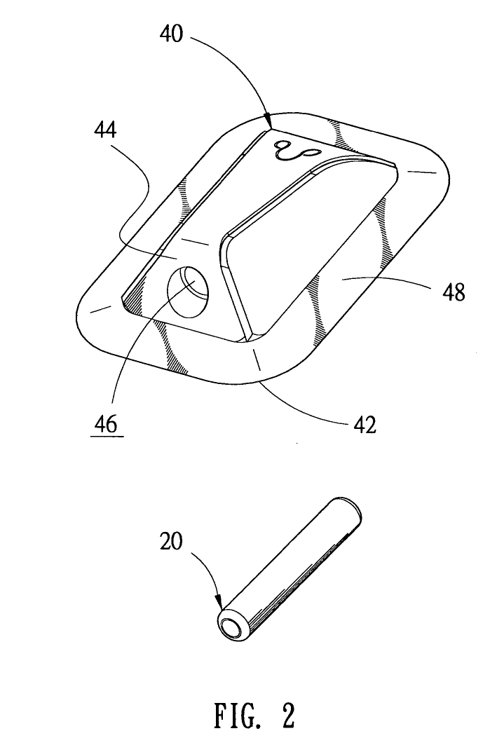

Referring to FIG. 1 and FIG. 2, an audio signal adapter 100 of the present invention comprises a plug 10 and a metal jack 20 of an electronic apparatus, which are electronically connected to two terminals of a cable 30 respectively. The metal jack 20 is embedded in a plastic set 40. In this embodiment, the electronic apparatus may be an earphone or a microphone. That is, the plug 10 may be an earphone plug or a microphone plug. Correspondingly, the metal jack 20 may be an earphone jack or a microphone jack.

The plastic set 40 includes a thin and flat base 42. The bottom of the base 42 is a smooth plane and suitable for sewing and sticking to the external ornament of a bag. The top central section of the base 42 extends upward in order to form a socket 44. A slot 46 is defined in the front of the socket 44. The metal jack 20 is embedded in the slot 46. The top plane of the base 42 extends outward with a small angle from the common boundary between the top plane of the base 42 and the socket 44 to form a base outskirts 48 of which thickness gradually reduces from the common boundary to the base 42. The outside edge of the base outskirts 48 coincides with the bottom edge of the base 42 to provide a thinner and softer operation position for convenient sewing and sticking.

As assembling, the base 42 is fixed to the external ornament of a bag by typical assembling method such as sewing and sticking. The plug 10, the cable 30 and MP3, CD or mobile phone electronic device can be placed in the bag.

In practice, a user can insert the plug 10 of the audio signal adapter 100 into the jack of the electronic device, such as the earphone and the microphone. The plug of the electronic apparatus is inserted into the metal jack 20 of the audio signal adapter 100. Then user can receive and transmit audio signals with original earphone or microphone.

As described above, the metal jack 20 is embedded and fixed in the plastic set 40. With the design of the thin and flat base 42, the plastic set 40 is firmly and conveniently fixed to the external ornament of the bag, so as to reduce the frequent drop of the earphone and microphone.

While the present invention has been described with reference to a specific embodiment thereof, the description is illustrative and is not to be construed as limiting the invention. Those may make various modifications to the present invention to the preferred embodiment skilled in the art without departing from the true spirit and scope of the invention as defined by the appended claims.

What is claimed is:

1. An audio signal adapter comprising:
a plug and a metal jack of an electronic apparatus, which are electronically connected to two terminals of a cable respectively;
a plastic set in which the metal jack is embedded, and the plastic set having a thin and flat base for fixing to an external ornament, the top central section of the base of the plastic set extending upward in order to form a socket, a slot being defined in the front of the socket, the metal jack being embedded in the slot.

2. The audio signal adapter as claimed in claim 1, wherein the bottom of the thin and flat base is a smooth plane.

3. The audio signal adapter as claimed in claim 1, wherein the top plane of the base extending outward with a small angle from the common boundary between the top plane of the base and the socket to form a base outskirts of which thickness gradually reducing from the common boundary to the base.

4. The audio signal adapter as claimed in claim 3, wherein the outside edge of the base outskirts coinciding with the bottom edge of the base.

5. The audio signal adapter as claimed in claim 1, wherein the electronic apparatus is an earphone.

6. The audio signal adapter as claimed in claim 1, wherein the electronic apparatus is a microphone.
